(19) United States
(12) Patent Application Publication
(10) Pub. No.: US 2006/0014575 A1
(43) Pub. Date: Jan. 19, 2006

(54) Communication module with multiple functions

(76) Inventors: Hung-Wei Tseng, Tainan City (TW); Yueh-Lin Tsai, Shulin Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/033,718

(22) Filed: Jan. 13, 2005

(30) Foreign Application Priority Data
Jul. 16, 2004 (TW) 93211336

(51) Int. Cl. H04M 1/00

(52) U.S. Cl. 455/575.4; 455/550.1

(57) ABSTRACT

A communication module with multiple functions includes a mobile communication device and a GPS module. The mobile communication device has a sliding mobile phone structure, and an embedded antenna module installed at one end side thereof. The sliding mobile phone structure has a top casing and a bottom casing slidably mating with each other. The GPS module is installed at another end side of the mobile communication device. Whereby, when the top casing and the bottom casing are closed the device can be used as a “mobile phone”, and when the top casing and the bottom casing are opened the device can be used as a “GPS”.

### BACKGROUND OF THE INVENTION

1. Field of the Invention

The present invention relates to a communication module with multiple functions, and particularly relates to a communication module having a sliding mobile phone structure for reducing signal interference between an embedded module and a GPS module.

2. Description of the Related Art

FIG. 1 shows a perspective, assembled view of the communication module of the prior art (Referring to U.S. Pat. No. 5,786,789). The communication module of prior art includes a mobile communication device 10 and a GPS (Global Positioning System) 20 connected. The mobile communication device 10 has an antenna module 100 installed therein. The antenna module 100 and the GPS 20 are mated for performing their dual functions as a mobile phone and a GPS.

However, the mobile communication device 10 and the GPS 20 are limited by the casing structure of the prior art. Hence, when the communication module of prior art is used, signals of the mobile communication device 10 and the GPS 20 interfere with each other.

With the employment of unique considerations and application of theories, and based on several years experience in specialized production of all flexible assembly systems and mechanisms, the inventor has come up with an innovative communication module with multiple functions.

### SUMMARY OF THE INVENTION

The first objective of the present invention is to provide a communication module with multiple functions. The communication module has an embedded antenna module and a GPS module. The embedded antenna module is installed in a top end side of the casing. The GPS module should be installed at the bottom end side of the casing, as far away as possible from the embedded antenna module. Such a placement will assist in the reduction of signal interference between the embedded antenna module and the GPS module.

In order to achieve the above objectives, the present invention provides a communication module with multiple functions including a mobile communication device and a GPS module. The mobile communication device has a sliding mobile phone structure, and an embedded antenna module installed at one end side thereof. The sliding mobile phone structure has a top casing and a bottom casing slidably mating with each other. The GPS module is installed at another end side of the mobile communication device. Whereby, when the top casing and the bottom casing are closed the device is used as a “mobile phone”, and when the top casing and the bottom casing are opened the device is used as a “GPS”.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objectives and advantages of the present invention will be more readily understood from the following detailed description when read in conjunction with the appended drawing, in which:

FIG. 1 is a perspective, assembled view of the communication module of the prior art;

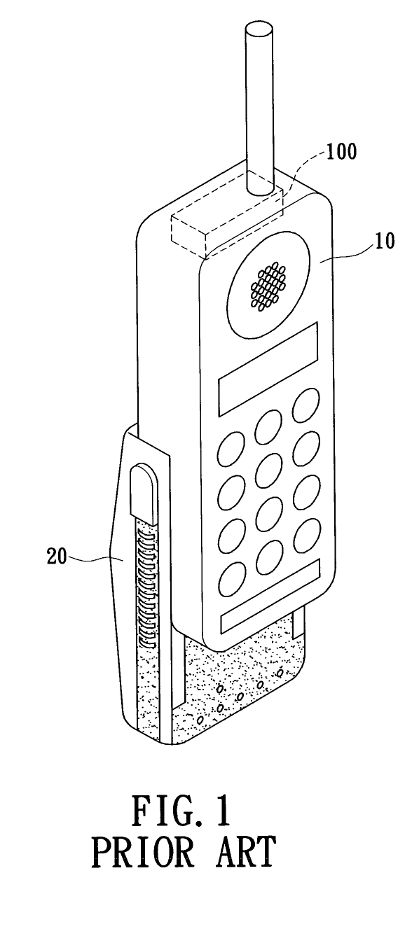

FIG. 2 is a perspective, exploded view of the communication module with multiple functions of the present invention;

FIG. 3 is a perspective, assembled view of the communication module with multiple functions of the present invention (when the top casing and the bottom casing are closed);

FIG. 4 is a perspective, assembled view of when the display device is opened according to the present invention; and

FIG. 5 is a perspective, assembled view of when the top casing and the bottom casing are opened according to the present invention.

### DETAILED DESCRIPTION OF PREFERRED EMBODIMENTS

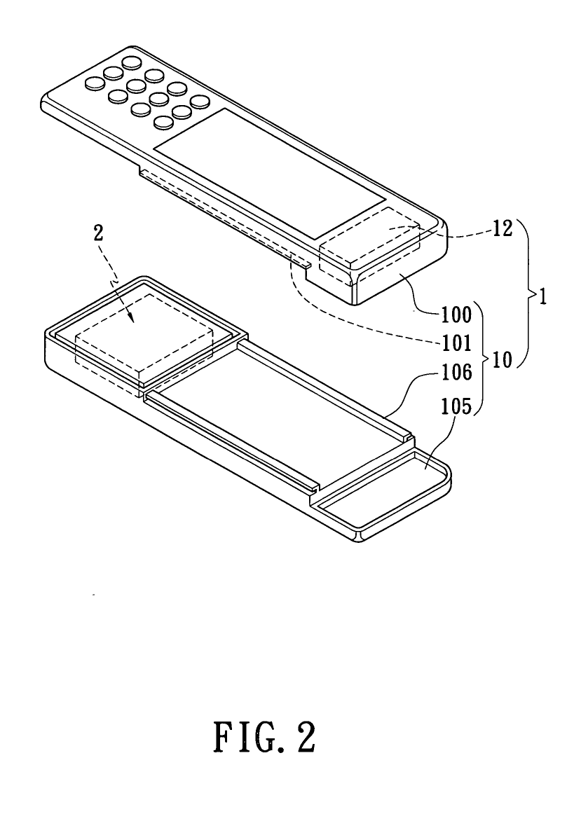

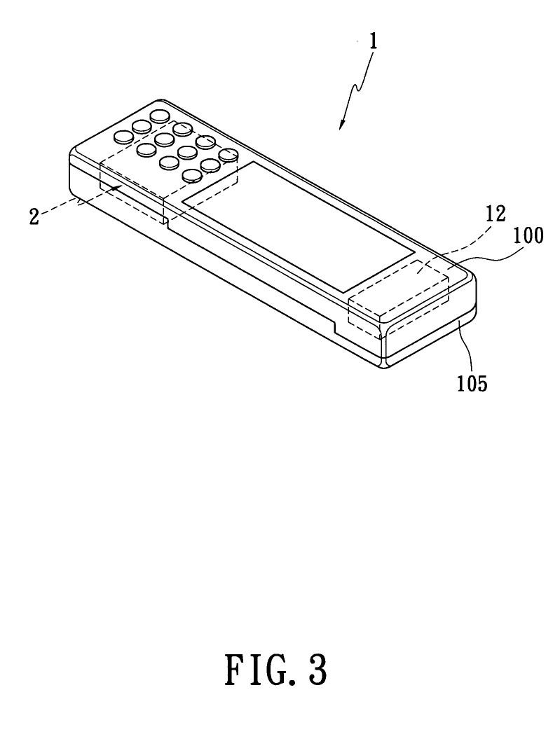

Referring to FIGS. 2 and 3, the present invention provides a communication module with multiple functions including a mobile communication device 1 and a GPS module 2.

The mobile communication device 1 has a sliding mobile phone structure 10, and an embedded antenna module 12 installed at one end side thereof. The embedded antenna module 12 is a GSM (Global System for Mobile Communications), a PCS (Personal Communication System) or a DCS (Digital Communication System) frequency band. The GPS module 2 is installed at another end side of the mobile communication device 1.

The sliding mobile phone structure 10 has a top casing 100 and a bottom casing 105 slidably mating with each other. The top casing 100 has a first sliding groove 101 formed thereon. The bottom casing 105 has a second sliding groove 106 formed thereon that corresponds to the first sliding groove 101. Whereby, the first sliding groove 101 and the second sliding groove 106 can be mated with each other for the top casing 100 and the bottom casing 105 to ‘open’ or ‘close’.

The embedded antenna module 12 is installed as far away as possible from the GPS module 2 in an end side of the top casing 100. The GPS module 2 is installed in an end side of the bottom casing 105 and far away as possible from the embedded antenna module 12.

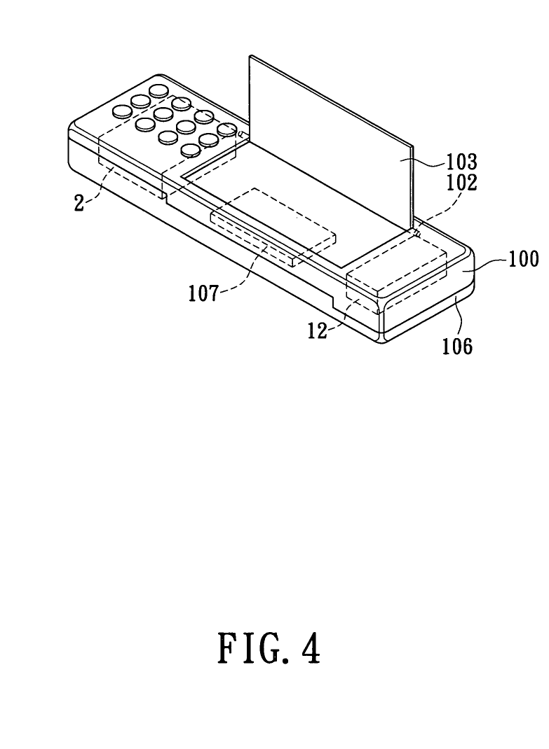

FIG. 4 shows a perspective, assembled view of the opened display device according to the present invention. The top casing 100 further includes a pair of pivot axles 102, and a display device 103 pivoted on the top casing 100 by the pivot axles 102 for opening or closing relative to the top casing 100.

The bottom casing 105 further includes a support 107 installed on a bottom side thereof for supporting or positioning the mobile communication device 1 on the dashboard of a vehicle. When the mobile communication device 1 is placed in the vehicle, and the display device 103 is opened, its design is convenient and safe so that a user may use the communication module whilst driving.

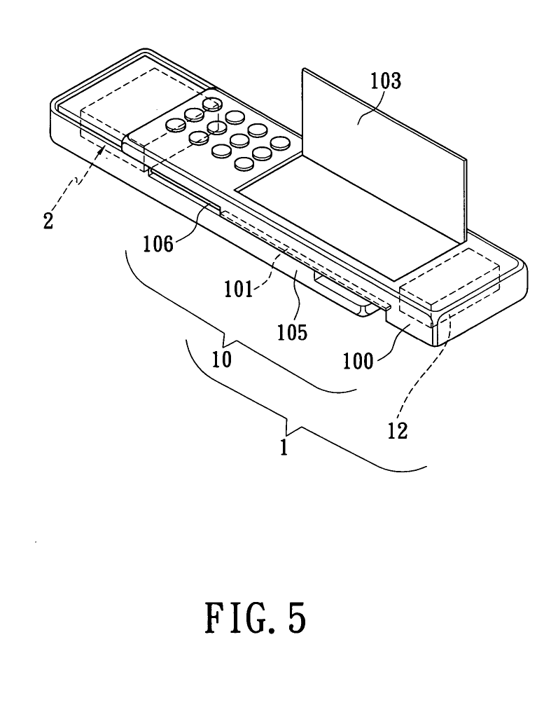

FIG. 5 shows a perspective, assembled view of when the top casing and the bottom casing are opened according to the present invention. When the top casing 100 and the bottom casing 105 are closed (at this time, the top casing 100 shields the GPS module 2), the mobile communication device 1 mates with the embedded antenna module 12 so that it can be used as a “mobile phone”. When the top casing 100 and the bottom casing 105 are opened to expose the GPS module 2, the mobile communication device 1 mates with the GPS module 2 and the display device 103 so that it can be used as a “GPS”.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A communication module with multiple functions, comprising:
a mobile communication device having a sliding mobile phone structure, and an embedded antenna module installed at one end side thereof, and the sliding mobile phone structure having a top casing and a bottom casing slidably mating with each other; and
a GPS module installed at another end side of the mobile communication device;
whereby, when the top casing and the bottom casing are closed for using as a “mobile phone”, and when the top casing and the bottom casing are opened for using as a “GPS”.

2. The antenna module as claimed in claim 1, wherein the embedded antenna module is a GSM, a PCS or a DCS frequency band.

3. The antenna module as claimed in claim 1, wherein the top casing has a first sliding groove formed thereon, and the bottom casing has a second sliding groove formed thereon which corresponds to the first sliding groove.

4. The antenna module as claimed in claim 1, wherein the embedded antenna module is installed in an end side of the top casing and far away from the GPS module in a predetermined distance.

5. The antenna module as claimed in claim 1, wherein the GPS module is installed in an end side of the bottom casing and far away from the embedded antenna module in a predetermined distance.

6. The antenna module as claimed in claim 1, wherein the top casing includes a pair of pivot axles, and a display device pivoted on the top casing by the pivot axles for opening or closing relative to the top casing.

7. The antenna module as claimed in claim 1, wherein the bottom casing includes a support installed on a bottom side thereof for supporting or positioning the mobile communication device.
